(19) United States
(12) Patent Application Publication
(10) Pub. No.: US 2026/0016693 A1
(43) Pub. Date: Jan. 15, 2026

(54) HEADS UP DISPLAY SYSTEM AND VEHICLE

(71) Applicant: Xiamen Tianma Microelectronics Co., Ltd., Xiamen (CN)

(72) Inventor: Liting FANG, Xianmen (CN)

(73) Assignee: Xiamen Tianma Microelectronics Co., Ltd., Xiamen (CN)

(21) Appl. No.: 19/335,365

(22) Filed: Sep. 22, 2025

(30) Foreign Application Priority Data
May 28, 2025 (CN) 202510697510.7

(51) Int. Cl. G02B 27/01

(52) U.S. Cl. CPC G02B 27/0101; G02B 2027/0118

(57) ABSTRACT

Provided are a heads up display system and a vehicle. An image generating device emits image light, which is reflected to a projection surface through a reflective assembly; a wavelength-selective reflective film is located on a reflective surface of the reflective assembly, realizing the selective reflection for different wavelength bands. The wavelength-selective reflective film is configured for reflecting at least part of the image light, ensuring that the image light is not affected by the arrangement of the wavelength-selective reflective film. When external interference light enters the heads up display system along a reverse optical path of the image light, the external interference light will first enter the wavelength-selective reflective film before entering the image generating device. The wavelength-selective reflective film only reflects interference light with the same wavelength band as the image light, thereby preventing the most of the interference light from entering the image generating device.

### CROSS-REFERENCE TO RELATED APPLICATION

The present application claims priority to Chinese Patent Application No. 202510697510.7, filed on May 28, 2025, the content of which is incorporated herein by reference in its entirety.

### TECHNICAL FIELD

The present disclosure relates to the field of display technologies, and in particular, to a heads up display system and a vehicle.

### BACKGROUND

With the continuous development of science and technology, a variety of display technologies have been widely applied in different fields. Nowadays, to improve driving safety, some vehicles are equipped with a heads up display system on their front windshields. The Head Up Display (abbreviated as HUD) system refers to the projection of important driving information such as speed per hour and navigation onto the front windshield in front of a driver, enabling the driver to see important driving information such as speed per hour and navigation without lowering their head, turning their head, or taking their eyes off the road ahead, thereby improving driving safety.

Due to the reversibility of an optical path, the problem of backflow of external interference light such as sunlight will affect the operating performance of an image generating device in the heads up display system. For example, it may cause the temperature of the image generating device to rise, thereby affecting the service life and imaging quality of the image generating device, etc.

### SUMMARY

In view of the above-mentioned problem, the present disclosure provides a heads up display system and a vehicle, which significantly reduce the impact of the problem of backflow of external interference light such as sunlight on the image generating device.

The present disclosure provides a heads up display system, including: an image generating device, a reflective assembly, and a wavelength-selective reflective film located on a reflective surface of the reflective assembly. The reflective assembly is configured to reflect image light emitted by the image generating device to a projection surface. The wavelength-selective reflective film is configured to reflect at least part of the image light.

Based on the same inventive concept, the present disclosure further provides a vehicle, including the above-mentioned heads up display system.

### BRIEF DESCRIPTION OF DRAWINGS

In conjunction with the accompanying drawings and with reference to the following specific implementations, the above-mentioned features and other features, advantages, and aspects of the embodiments of the present disclosure will become more apparent. Throughout the accompanying drawings, the same or similar reference signs denote the same or similar elements. It should be understood that the accompanying drawings are schematic, and components and elements are not necessarily drawn to scale.

FIG. 1 is a principle structural schematic diagram of a heads up display system according to an embodiment of the present disclosure;

FIG. 2 is a principle structural schematic diagram of another heads up display system according to an embodiment of the present disclosure;

FIG. 3 is an internal structural schematic diagram of a wavelength-selective reflective film according to an embodiment of the present disclosure;

FIG. 4 is a principle structural schematic diagram of yet another heads up display system according to an embodiment of the present disclosure;

FIG. 5 is a principle structural schematic diagram of yet another heads up display system according to an embodiment of the present disclosure;

FIG. 6 is a schematic diagram of zoning of a wavelength-selective reflective film according to an embodiment of the present disclosure;

FIG. 7 is an internal structure schematic diagram of another wavelength-selective reflective film according to an embodiment of the present disclosure;

FIG. 8 is a principle schematic diagram of zoned reflection of a wavelength-selective reflective film according to an embodiment of the present disclosure;

FIG. 9 is a principle schematic diagram of zoned reflection of another wavelength-selective reflective film according to an embodiment of the present disclosure;

FIG. 10 is a principle schematic diagram of zoned reflection of yet another wavelength-selective reflective film according to an embodiment of the present disclosure;

FIG. 11 is a schematic diagram of zoning of another wavelength-selective reflective film according to an embodiment of the present disclosure;

FIG. 12 is a schematic diagram of zoning of yet another wavelength-selective reflective film according to an embodiment of the present disclosure;

FIG. 13 is a schematic diagram of zoning of yet another wavelength-selective reflective film according to an embodiment of the present disclosure;

FIG. 14 is a schematic diagram of zoning of yet another wavelength-selective reflective film according to an embodiment of the present disclosure;

FIG. 15 is a schematic diagram of zoning of yet another wavelength-selective reflective film according to an embodiment of the present disclosure;

FIG. 16 is a schematic diagram of zoning of yet another wavelength-selective reflective film according to an embodiment of the present disclosure;

FIG. 17 is a schematic diagram of zoning of yet another wavelength-selective reflective film according to an embodiment of the present disclosure;

FIG. 18 is a schematic diagram of zoning of yet another wavelength-selective reflective film according to an embodiment of the present disclosure;

FIG. 19 is a schematic diagram of zoning of yet another wavelength-selective reflective film according to an embodiment of the present disclosure;

FIG. 20 is a schematic diagram of zoning of yet another wavelength-selective reflective film according to an embodiment of the present disclosure;

FIG. 21 is a schematic diagram of zoning of yet another wavelength-selective reflective film according to an embodiment of the present disclosure; and

FIG. 22 is a schematic diagram of a vehicle equipped with a heads up display system according to an embodiment of the present disclosure.

### DESCRIPTION OF EMBODIMENTS

Embodiments of the present disclosure are described below in conjuction with the accompanying drawings in the embodiments of the present disclosure. The terms used in the “DESCRIPTION OF EMBODIMENTS” section of the present disclosure are only for explaining specific embodiments of the present disclosure and are not intended to limit the present disclosure. A person of ordinary skill in the art would know that the technical solutions provided by the embodiments of the present disclosure are also applicable to similar technical problems with the development of technologies and the emergence of new scenarios.

Based on the content recorded in the background art, during the invention and creation process of the present disclosure, it was found that due to the reversibility of the optical path of the heads up display system, the backflow of external interference light such as sunlight will enter the image generating device. Since external interference light such as sunlight has strong energy, the energy will cause the temperature of the image generating device to rise, thereby affecting the operating performance of the image generating device. In more severe cases, it may even damage the internal devices of the image generating device.

In general, the problem of backflow of external interference light such as sunlight will affect the operating performance of the image generating device in the heads up display system, e.g., causing temperature rise of the image generating device, thereby affecting the service life and imaging quality of the image generating device.

Based on this, the present disclosure provides a heads up display system and a vehicle, which can significantly reduce the impact of the problem of backflow of external interference light on the image generating device, and improve the service life and imaging quality of the image generating device.

To make the above objectives, features, and advantages of the present disclosure more apparent and understandable, the present disclosure is further described in detail below in conjunction with the accompanying drawings and specific embodiments.

It should be noted that the directional terms presented in the present disclosure are based on the relative positional relationships shown in the drawings and cannot be used as absolute limitations on the present disclosure.

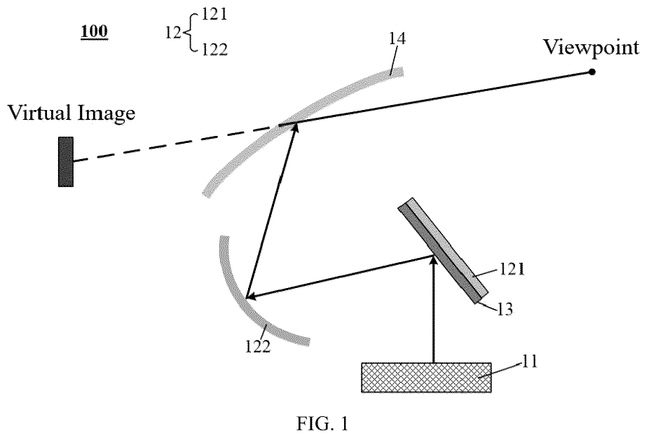

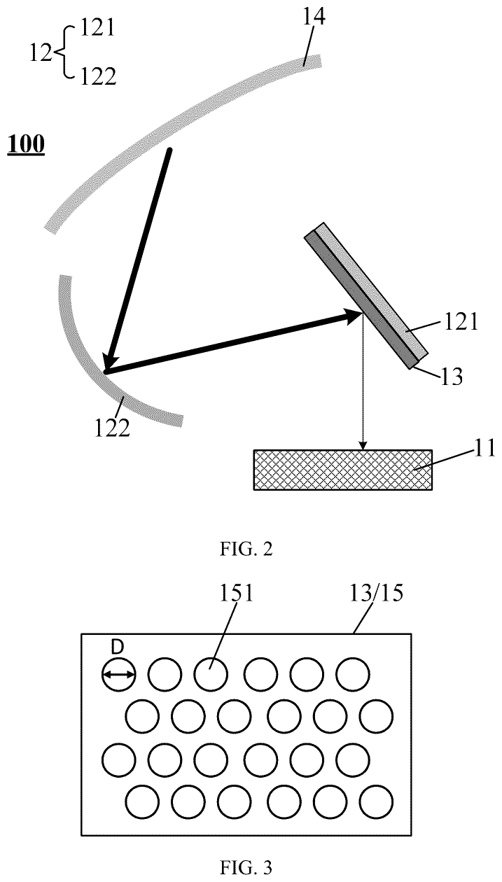

Refer to FIG. 1 and FIG. 2, where FIG. 1 is a principle structural schematic diagram of a heads up display system according to an embodiment of the present disclosure; and FIG. 2 is a principle structural schematic diagram of another heads up display system according to an embodiment of the present disclosure, the heads up display system 100 according to the embodiments of the present disclosure includes: an image generating device 11, a reflective assembly 12, and a wavelength-selective reflective film 13 located on a reflective surface of the reflective assembly 12.

Image light emitted by the image generating device 11 is reflected to a projection surface 14 through the reflective assembly 12.

The wavelength-selective reflective film 13 reflects at least part of the image light.

In an embodiment of the present disclosure, as shown in FIG. 1, the image generating device 11 emits the image light, which is reflected to the projection surface 14 through the reflective assembly 12. The wavelength-selective reflective film 13 is located on the reflective surface of the reflective assembly 12, realizing the function of selective reflection for different wavelength bands. The wavelength-selective reflective film 13 is configured for reflecting at least part of the image light, ensuring that the image light is not affected by the arrangement of the wavelength-selective reflective film 13.

As shown in FIG. 2, when external interference light enters the heads up display system 100 along a reverse optical path of the image light, since the wavelength-selective reflective film 13 is located on the reflective surface of the reflective assembly 12, the external interference light will first enter the wavelength-selective reflective film 13 before entering the image generating device 11. The wavelength-selective reflective film 13 only reflects interference light with the same wavelength band as the image light, thereby absorbing and filtering out most of the interference light with wavelength bands different from the image light, preventing the most of the interference light from entering the image generating device 11, which significantly reduces the impact of the problem of backflow of external interference light on the image generating device 11, and improves the service life and imaging quality of the image generating device 11.

It should be noted that in FIG. 2, a thicker arrow represents the propagation direction of external interference light with stronger energy, and a thinner arrow represents the propagation direction of external interference light with weaker energy. It can be seen that after the external interference light with stronger energy enters the wavelength-selective reflective film 13, most of the interference light with wavelength bands different from the image light is absorbed and filtered out by the wavelength-selective reflective film 13, so that it cannot enter the image generating device 11. At this time, only part of the external interference light with weaker energy can enter the image generating device 11. Apparently, arranging the wavelength-selective reflective film 13 on the reflective assembly 12 can significantly reduce the impact of the problem of backflow of external interference light on the image generating device 11, i.e., significantly reduce the temperature rise and imaging impact caused by the problem of backflow of external interference light, thereby improving the service life and imaging quality of the image generating device 11.

In general, most of the external interference light is difficult to be reflected by the wavelength-selective reflective film 13, instead, the external interference light is absorbed and filtered out by the wavelength-selective reflective film 13, and thus cannot propagate to the image generating device 11 in the subsequent optical path. This not only ensures that the heads up display system 100 can project the image light normally, but also reduces the amount of external interference light entering the image generating device 11, reduces the heat in the interior of the image generating device 11, and then improves safety.

For example, the external interference light includes but is not limited to ultraviolet light and infrared light. Ultraviolet light may accelerate the aging and performance degradation of the devices in the image generating device 11, affecting the service life of the heads up display system 100. Infrared light has very high power, and when propagating to the image generating device 11, it will bring a lot of heat to the image generating device 11, causing damage of the image generating device 11. In the embodiment of the present disclosure, the wavelength-selective reflective film 13 can at least filter out infrared light and ultraviolet light, in other words, the wavelength-selective reflective film 13 can filter out infrared light with a wavelength of 730 nm-2500 nm and ultraviolet light with a wavelength of 10 nm-400 nm. Meanwhile, since the wavelength band of the image light does not overlap with the wavelength bands of infrared light and ultraviolet light (e.g., the wavelength range of red light is approximately 600 nm-700 nm, the wavelength range of green light is approximately 492 nm-577 nm, and the wavelength range of blue light is approximately 400 nm-500 nm, which do not overlap with the wavelength bands of infrared light and ultraviolet light). Therefore, the wavelength-selective reflective film 13 that filters out infrared light and ultraviolet light will not affect the image light, thereby ensuring the normal display of the heads up display system 100.

For example, the wavelength-selective reflective film 13 can only reflect light with a wavelength of 400 nm-700 nm, and can absorb and filter out light with a wavelength outside 400 nm-700 nm. In other words, based on the wavelength-selective reflection characteristic of the wavelength-selective reflective film 13, external interference light outside a specific wavelength range is blocked from entering the image generating device 11.

The image generating device 11 is used to modulate and emit the image light. The image generating device 11 includes but is not limited to a Picture Generation Unit (PGU), etc. The image generating device 11 can obtain vehicle information through a vehicle's sensors, wireless devices, etc., and modulate it into image light for emission. The image generating device 11 has a light-emitting surface, and the number of light-emitting surfaces can be one or more. The image light can be emitted from a single light-emitting surface or multiple light-emitting surfaces simultaneously. The image generating device 11 can project information such as images or text onto the projection surface 14 in a visible or invisible form by controlling the light intensity, color, and direction of the image light. Such projection is usually realized by encoding information such as images or text into a series of sub-pixels, and then controlling the intensity and color of light from each sub-pixel.

For example, a display unit in the image generating device 11 includes but is not limited to a liquid crystal display unit, an Organic Light Emitting Diode (OLED) display unit, or a Micro-LED (Micro-Light Emitting Diode) display unit.

In an optional embodiment of the present disclosure, referring to FIG. 3, which is an internal structural schematic diagram of a wavelength-selective reflective film according to an embodiment of the present disclosure, the wavelength-selective reflective film 13 is a photonic crystal reflective film 15, and the photonic crystal reflective film 15 includes microsphere particles 151.

Diameters and/or volume fractions of the microsphere particles 151 are determined based on the wavelength band for which the wavelength-selective reflective film 13 needs to perform selective reflection.

For example, if the wavelength-selective reflective film 13 only reflects light with a wavelength of 400 nm-700 nm, the diameters and/or volume fractions of the microsphere particles 151 are determined based on the wavelength band of 400 nm-700 nm.

In an embodiment of the present disclosure, a photonic crystal is an artificial periodic dielectric structure with photonic bandgap characteristics, which can prevent waves in a certain frequency range from propagating in the periodic structure, i.e., this structure itself has a “forbidden band”.

D is a diameter of the microsphere particle 151, n_{eff} is an effective refractive index, nₛ is a refractive index of the microsphere particle 151, fₛ is a volume fraction of the microsphere particle 151, and there exists a relationship of n_{eff}²=nₛ² fₛ+nₐᵢᵣ²(1−fₛ). Combined with Bragg's equation nλ=2 d sin θ (where d is an interplanar spacing, n is a reciprocal of the average refractive index, and θ is a Bragg diffraction angle), and based on a face-centered cube, d=0.816D, a relationship between the wavelength λ and the diameter D of the microsphere particle 151 is λ=1.63*D*sin θ/ne_{ff}.

It can be seen that when the photonic crystal reflective film 15 is used as the wavelength-selective reflective film 13, selective reflection for different wavelength bands can be realized by adjusting the diameters and/or volume fractions of the microsphere particles 151, which can block most of the external ambient light from entering the image generating device 11 while ensuring the reflection and imaging of the image light emitted by the image generating device 11.

Optionally, a material of the microsphere particles 151 includes but is not limited to Silicon Dioxide (SiO₂), Polymeric Methyl Methacrylate (PMMA), or Polystyrene (PS).

In an optional embodiment of the present disclosure, as shown in FIGS. 1 and 2, the reflective assembly 12 includes a first mirror 121 and a second mirror 122 sequentially arranged in a transmission optical path of the image light.

In an embodiment of the present disclosure, the first mirror 121 is configured to receive and reflect the image light, and the second mirror 122 is configured to receive the image light reflected by the first mirror 121 and reflect the image light reflected by the first mirror 121 to the projection surface 14. The first mirror 121 and the second mirror 122 can be plane mirrors, convex mirrors, concave mirrors, etc., which can be limited according to specific implementation requirements and are not limited in the embodiments of the present disclosure.

For example, as shown in FIGS. 1 and 2, the first mirror 121 is illustrated as a plane mirror, and the second mirror 122 is illustrated as a concave mirror. The first mirror 121 changes the propagation path of the image light, so that a beam of the image light is reflected and propagates to the reflective surface of the second mirror 122. The second mirror 122 can converge the beam of the image light and change the propagation path of the image light, so that the beam of the image light is reflected and propagates to the projection surface 14.

It should be noted that the types, positions, angles and the like of the first mirror 121 and the second mirror 122 can be flexibly adjusted according to implementation requirements to achieve the best image projection effect and preset propagation path.

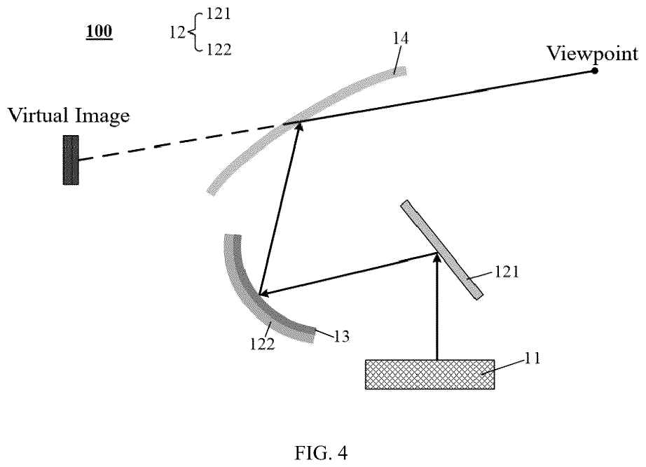

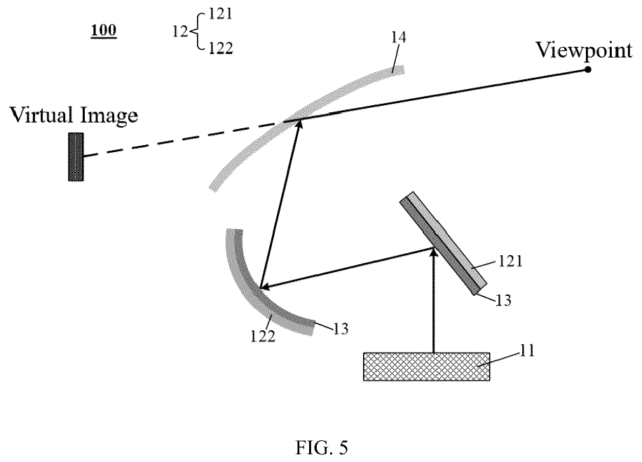

In an optional embodiment of the present disclosure, refer to FIG. 4 and FIG. 5, where FIG. 4 is a principle structural schematic diagram of yet another heads up display system according to an embodiment of the present disclosure; and FIG. 5 is a principle structural schematic diagram of yet another heads up display system according to an embodiment of the present disclosure, the wavelength-selective reflective film 13 is located on a reflective surface of the first mirror 121, and/or the wavelength-selective reflective film 13 is located on a reflective surface of the second mirror 122.

In an embodiment of the present disclosure, as shown in FIGS. 1 and 2, the wavelength-selective reflective film 13 is located on the reflective surface of the first mirror 121, i.e., the reflective surface of the first mirror 121 is provided with the wavelength-selective reflective film 13, but the reflective surface of the second mirror 122 is not provided with the wavelength-selective reflective film 13. In another embodiment of the present disclosure, as shown in FIG. 4, the wavelength-selective reflective film 13 is located on the reflective surface of the second mirror 122, i.e., the reflective surface of the second mirror 122 is provided with the wavelength-selective reflective film 13, but the reflective surface of the first mirror 121 is not provided with the wavelength-selective reflective film 13. In yet another embodiment of the present disclosure, as shown in FIG. 5, the wavelength-selective reflective film 13 is located on the reflective surface of the first mirror 121, and the wavelength-selective reflective film 13 is also located on the reflective surface of the second mirror 122, i.e., the reflective surface of the first mirror 121 is provided with the wavelength-selective reflective film 13, and also the reflective surface of the second mirror 122 is provided with the wavelength-selective reflective film 13.

Further, when the reflective surface of the second mirror 122 is provided with the wavelength-selective reflective film 13, external interference light preferentially enters the second mirror 122, and at this time, the wavelength-selective reflective film 13 on the second mirror 122 can absorb and filter out most of the external interference light, reduce most of the energy of the external interference light, and reduce the heat dissipation requirement of the subsequent optical path.

In addition, when both the reflective surfaces of the first mirror 121 and the reflective surface of the second mirror 122 are provided with the wavelength-selective reflective films 13, the wavelength bands for selective reflection corresponding to the two wavelength-selective reflective films 13 can be different. For example, the wavelength band for selective reflection corresponding to the wavelength-selective reflective film 13 on the first mirror 121 is A1 nm-B1 nm, and the wavelength band for selective reflection corresponding to the wavelength-selective reflective film 13 on the second mirror 122 is A2 nm-B2 nm, where A1≠A2 and/or B1/B2. By reasonably designing the values of A1, A2, B1, and B2, the purpose of absorbing and filtering out the external interference light step by step can be achieved while normally reflecting the image light, so that the energy of the external interference light is reduced step by step, further improving the filtering-out effect and ensuring the normal use of the heads up display system 100.

It should be noted that the wavelength-selective reflective film 13 can also be arranged on other optical components, and by placing the other optical components in the optical path of the image light, at least part of the external interference light propagating along the reverse optical path of the heads up display system 100 can be absorbed and filtered out, reducing the energy of the external interference light.

In an optional embodiment of the present disclosure, a display unit in the image generating device 11 includes a plurality of sub-pixels, and the plurality of sub-pixels are one or more of a red sub-pixel, a green sub-pixel, a blue sub-pixel, and a white sub-pixel.

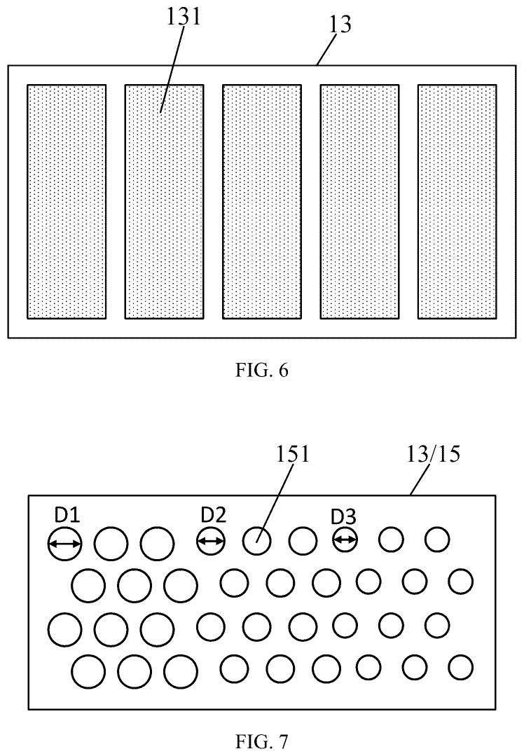

Refer to FIG. 6, which is a schematic diagram of zoning of a wavelength-selective reflective film according to an embodiment of the present disclosure, the wavelength-selective reflective film 13 includes at least one first region 131, and a part of the first regions 131 reflect red light emitted by the red sub-pixel, and/or a part of the first regions 131 reflect green light emitted by the green sub-pixel, and/or a part of the first regions 131 reflect blue light emitted by the blue sub-pixel, and/or a part of the first regions 131 reflect white light emitted by the white sub-pixel.

In an embodiment of the present disclosure, the diameters of the microsphere particles 151 in a part of the first regions 131 are different from the diameters of the microsphere particles 151 in another part of the first regions 131, and/or the volume fractions of the microsphere particles 151 in a part of the first regions 131 are different from the volume fractions of the microsphere particles 151 in another part of the first regions 131. That is, selective reflection for different wavelength bands can be realized by adjusting the diameters and/or volume fractions of the microsphere particles 151.

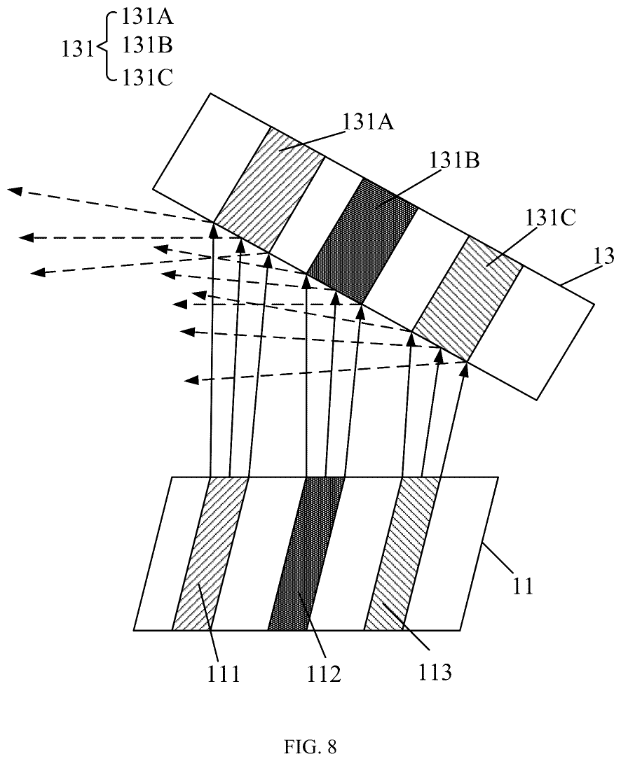

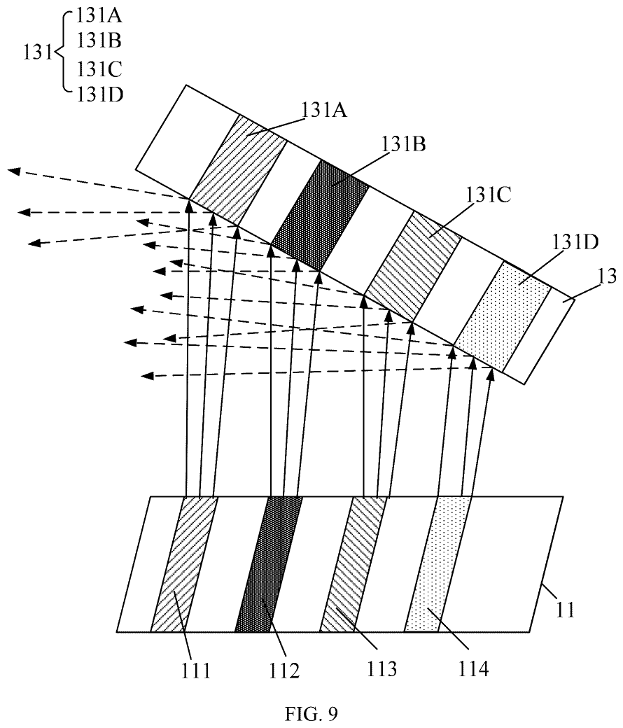

For example, as shown in FIG. 7, which is a schematic diagram of an internal structure of another wavelength-selective reflective film according to an embodiment of the present disclosure, D1≠D2≠D3, so that selective reflection for different wavelength bands in different first regions 131 is realized.

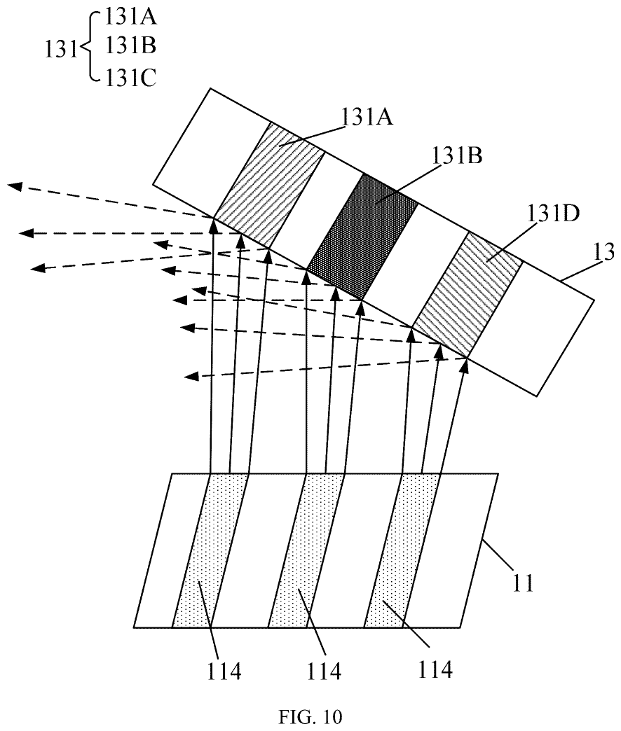

In a possible implementation, referring to FIG. 8, which is a principle schematic diagram of zoned reflection of a wavelength-selective reflective film according to an embodiment of the present disclosure, taking the display unit in the image generating device 11 including the red sub-pixel 111, the green sub-pixel 112, and the blue sub-pixel 113 as an example for illustration, selective reflection for different wavelength bands is realized by adjusting the diameters and/or volume fractions of the microsphere particles 151, so that a part of the first regions 131 reflect red light emitted by the red sub-pixel 111, a part of the first regions 131 reflect green light emitted by the green sub-pixel 112, and a part of the first regions 131 reflect blue light emitted by the blue sub-pixel 113, so as to realize full-color display.

For example, a region labeled 131A reflects red light emitted by the red sub-pixel 111, a region labeled 131B reflects green light emitted by the green sub-pixel 112, and a region labeled 131C reflects blue light emitted by the blue sub-pixel 113.

In a possible implementation, referring to FIG. 9, which is a principle schematic diagram of zoned reflection of another wavelength-selective reflective film according to an embodiment of the present disclosure, taking the display unit in the image generating device 11 including the red sub-pixel 111, the green sub-pixel 112, the blue sub-pixel 113, and the white sub-pixel 114 as an example for illustration, selective reflection for different wavelength bands is realized by adjusting the diameters and/or volume fractions of the microsphere particles 151, so that a part of the first regions 131 reflect red light emitted by the red sub-pixel 111, a part of the first regions 131 reflect green light emitted by the green sub-pixel 112, a part of the first regions 131 reflect blue light emitted by the blue sub-pixel 113, and a part of the first regions 131 reflect white light emitted by the white sub-pixel 114. On the basis of realizing full-color display, the white sub-pixel 114 is added to form a four-color sub-pixel design, which improves the consistency of color performance and significantly improves the light transmittance of the liquid crystal display unit. When displaying images with the same brightness, its power consumption is lower; and under the same power consumption, the brightness is significantly improved, making the image layers more distinct and the image more transparent.

For example, a region labeled 131A reflects red light emitted by the red sub-pixel 111, a region labeled 131B reflects green light emitted by the green sub-pixel 112, a region labeled 131C reflects blue light emitted by the blue sub-pixel 113, and a region labeled 131D reflects white light emitted by the white sub-pixel 114.

In the embodiments of the present disclosure, when the collimation of the backlight of the image generating device 11 is high, the wavelength-selective reflective film 13 can be zoned for reflection to improve the reflection effect of each color light, thereby improving the display effect of the heads up display system 100. For example, a part of the first regions 131 only reflect red light with a wavelength of 600 nm-700 nm, and absorb and filter out light with a wavelength outside 600 nm-700 nm; a part of the first regions 131 only reflect green light with a wavelength of 492 nm-577 nm, and absorb and filter out light with a wavelength outside 492 nm-577 nm; a part of the first regions 131 only reflect blue light with a wavelength of 400 nm-500 nm, and absorb and filter out light with a wavelength outside 400 nm-500 nm.

Further, compared with a scheme where the wavelength-selective reflective film 13 is not zoned and only reflects light with a wavelength of 400 nm-700 nm and absorbs and filters out light with a wavelength outside 400 nm-700 nm, the wavelength for selective reflection of the first regions 131 can be limited to a narrower range, so as to block more external interference light from entering the image generating device 11.

Similarly, for a display scheme where the light emitted by sub-pixels such as the red sub-pixel 111, the green sub-pixel 112, and the blue sub-pixel 113 is more purer, the wavelength band corresponding to each color light will be appropriately narrowed, and the wavelength for selective reflection corresponding to the wavelength-selective reflective film 13 can be limited to a narrower range (e.g., a narrow bandgap range) to block more external interference light from entering the image generating device 11.

It should be noted that in a case where the collimation of the backlight of the image generating device 11 is lower, to avoid the occurrence of problems such as the first regions 131 failing to receive the corresponding color light, which leads to light loss, the wavelength-selective reflective film 13 may not be subjected to zoning treatment. For example, the wavelength-selective reflective film 13 can be made to only reflect light with a wavelength of 400 nm-700 nm, and absorb and filter out all light with a wavelength outside 400 nm-700 nm, i.e., the wavelength-selective reflective film 13 simultaneously reflects red light emitted by the red sub-pixel 111, green light emitted by the green sub-pixel 112, blue light emitted by the blue sub-pixel 113, etc. In other words, the wavelength-selective reflective film 13 is not subjected to a zoning treatment, and is uniformly designed to be compatible with the spectrum of the display unit in the image generating device 11.

In a possible implementation, referring FIG. 10, which is a principle schematic diagram of zoned reflection of yet another wavelength-selective reflective film according to an embodiment of the present disclosure, taking the display unit in the image generating device 11 including only the white sub-pixel 114 as an example for illustration, selective reflection for different wavelength bands is realized by adjusting the diameters and/or volume fractions of the microsphere particles 151, so that a part of the first regions 131 reflect red light, a part of the first regions 131 reflect green light, and a part of the first regions 131 reflect blue light, so as to realize full-color display. For example, a region labeled 131A reflects red light, a region labeled 131B reflects green light, and a region labeled 131C reflects blue light.

Specifically, in the field of color display, including traditional liquid crystal displays, organic light-emitting diodes and other display technologies, traditional color filter substrates (also referred to as CF substrates in the field) are used to realize RGB color display. The traditional color filter substrates realize RGB display by filtering each primary color of the white light emitted by the white sub-pixel. Therefore, about ⅔ of the light will be absorbed and lost by the color filter substrate, resulting in low transmittance and affecting the display effect.

Based on this, in the embodiments of the present disclosure, the color filter substrate required for the display unit in the image generating device 11 can be directly removed. In the case where the wavelength-selective reflective film 13 is zoned, selective reflection for different wavelength bands is realized by adjusting the diameters and/or volume fractions of the microsphere particles 151, so that a part of the first regions 131 reflect red light, a part of the first regions 131 reflect green light, and a part of the first regions 131 reflect blue light, so as to realize RGB full-color display.

In other words, when white light emitted by the white sub-pixel 114 enters the region 131A that reflects red light, the region 131A can reflect the red primary color in the white light and filter out other colors of light; similarly, when white light emitted by the white sub-pixel 114 enters the region 131B that reflects green light, the region 131B can reflect the green primary color in the white light and filter out other colors of light; and similarly, when white light emitted by the white sub-pixel 114 enters the region 131C that reflects blue light, the region 131C can reflect the blue primary color in the white light and filter out other colors of light, so as to realize RGB full-color display.

Therefore, the image generating device 11 in the heads up display system 100 according to the embodiment of the present disclosure does not need a color filter substrate, and full-color display is realized by combining the selective reflection of different regions of the wavelength-selective reflective film 13. This in turn solves the technical problems caused by the arrangement of the color filter substrate, thereby reducing costs, improving the quality of the image light, and thus the inventive solution improves the display effect of the heads up display system 100.

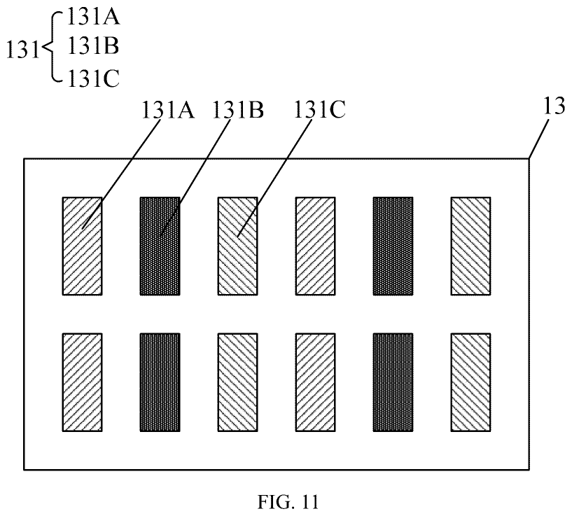

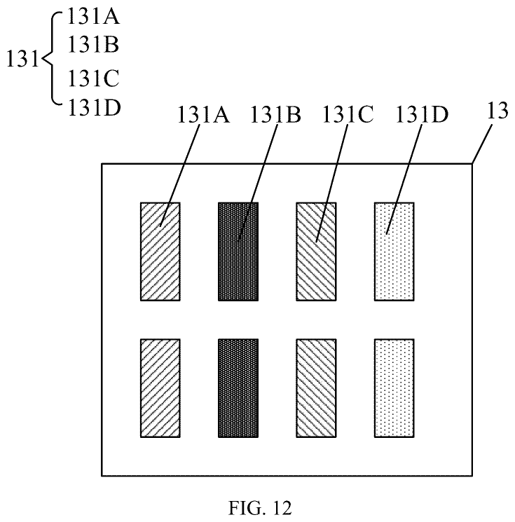

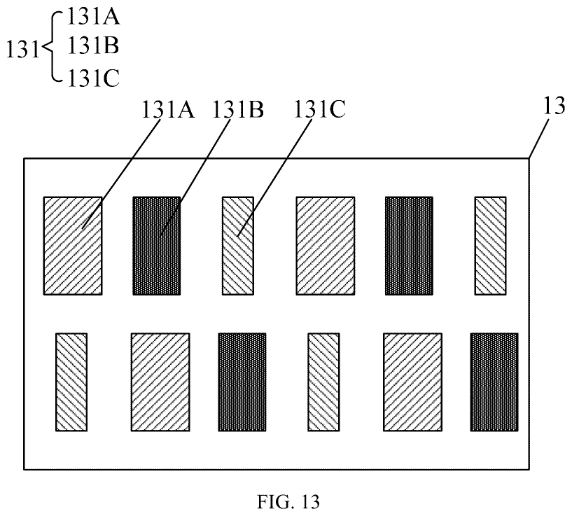

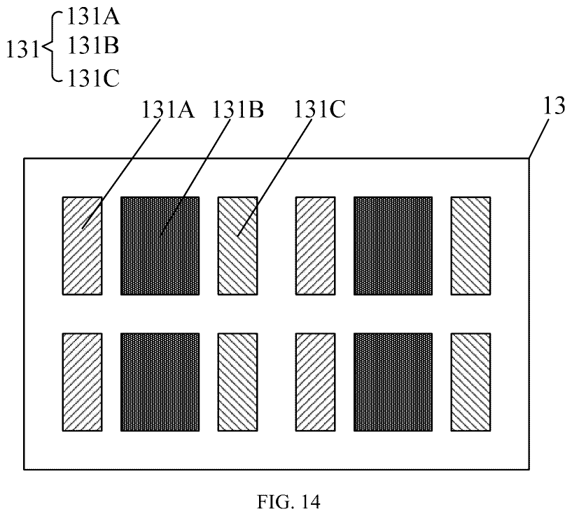

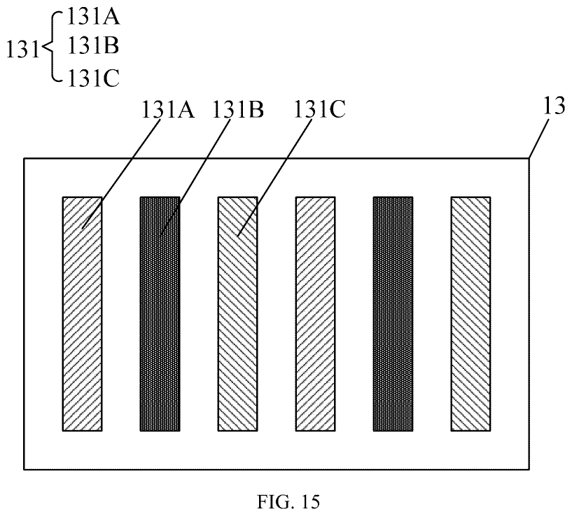

FIG. 11 is a schematic diagram of zoning of another wavelength-selective reflective film according to an embodiment of the present disclosure; FIG. 12 is a schematic diagram of zoning of yet another wavelength-selective reflective film according to an embodiment of the present disclosure; FIG. 13 is a schematic diagram of zoning of yet another wavelength-selective reflective film according to an embodiment of the present disclosure; FIG. 14 is a schematic diagram of zoning of yet another wavelength-selective reflective film according to an embodiment of the present disclosure; and FIG. 15 is a schematic diagram of zoning of yet another wavelength-selective reflective film according to an embodiment of the present disclosure. Considering that the arrangement modes of the sub-pixels in the display unit of the image generating device 11 is various, when performing the zoning treatment of the first regions 131 for the wavelength-selective reflective film 13, correspondingly designs can be made based on the actual sub-pixel arrangement modes. In other words, different first regions 131 of the wavelength-selective reflective film 13 can match the sub-pixel distribution of the display unit in the image generating device 11, and fine zoning reflection is realized by adjusting the diameters and/or volume fractions of the microsphere particles 151 in different first regions 131.

For example, when the red sub-pixels 111 in the display unit of the image generating device 11 are located in a column, as shown in FIG. 15, the region 131A that reflects red light emitted by the red sub-pixels 111 can be designed as a long strip shape, so as to reflect the red light emitted by the column of red sub-pixels 111, thereby simplifying the difficulty of zoning the first regions 131. As shown in FIGS. 11-14, it is possible that one first region 131 corresponds to one sub-pixel.

It should be noted that the zoning design of the first regions 131 for the wavelength-selective reflective film 13 is a corresponding design based on the actual arrangement mode of the sub-pixels. Therefore, in the embodiments of the present disclosure, the size of the light-emitting area of the sub-pixels is reflected through the size of different first regions 131.

As shown in FIGS. 11 and 12, the light-emitting areas of the multiple sub-pixels are the same.

As shown in FIG. 13, the sub-pixels include red sub-pixels 111, green sub-pixels 112, and blue sub-pixels 113, the light-emitting area of one of the red sub-pixels 111 is S1, the light-emitting area of one of the green sub-pixels 112 is S2, and the light-emitting area of one of the blue sub-pixels 113 is S3, where S1>S2>S3.

Considering that when the display unit in the image generating device 11 is a Micro-LED display unit, the light-emitting brightness of Micro-LEDs emitting red light is low, the light-emitting area of the red sub-pixel 111 can be increased to improve the brightness of red light, thereby improving the consistency of color performance and finally improving the display effect of the heads up display system 100.

As shown in FIG. 14, the sub-pixels include red sub-pixels 111, green sub-pixels 112, and blue sub-pixels 113, the light-emitting area of one of the red sub-pixels 111 is S1, the light-emitting area of one of the green sub-pixels 112 is S2, and the light-emitting area of one of the blue sub-pixels 113 is S3, where S2>S1 and S2>S3.

Considering that the human eye is more sensitive to green light, by increasing the light-emitting area of the green sub-pixel 112, the purpose of improving the brightness of green light can be achieved. This makes it possible to more accurately restore brightness information under the condition of limited sub-pixels (the human eye is more sensitive to brightness than chromaticity), thereby enhancing the performance of image details.

Apparently, in a scheme without a CF substrate, more first regions 131 can be used to selectively reflect green light to achieve the purpose of increasing the brightness of green light. For example, in the scheme without a CF substrate, the number of regions 131B reflecting green light in the wavelength-selective reflective film 13 is greater than the number of the regions 131A reflecting red light, and the number of the regions 131B reflecting green light is greater than the number of the regions 131C reflecting blue light.

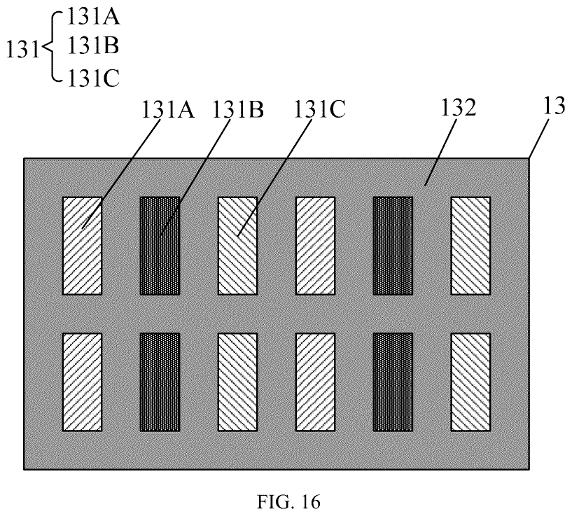

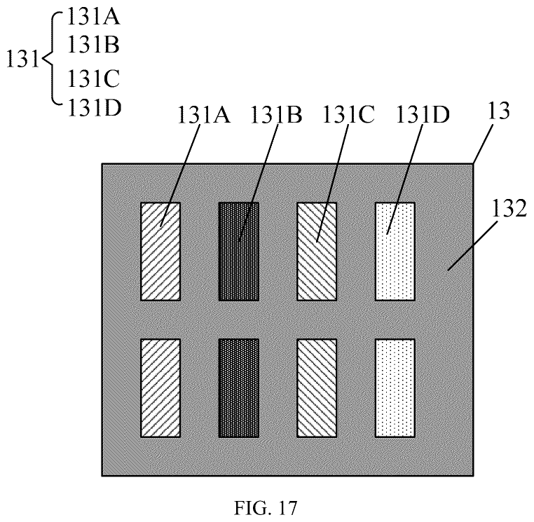

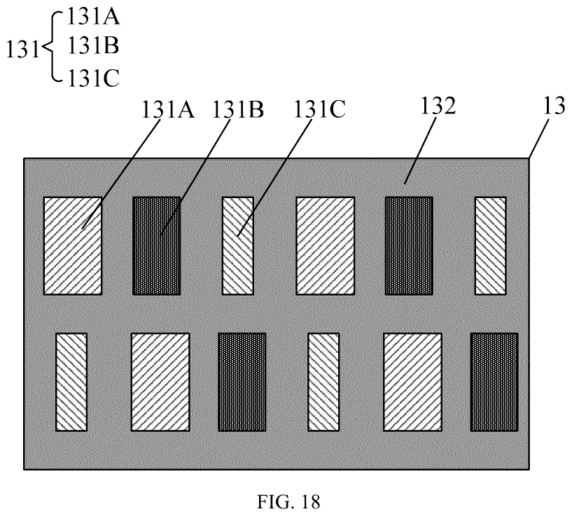

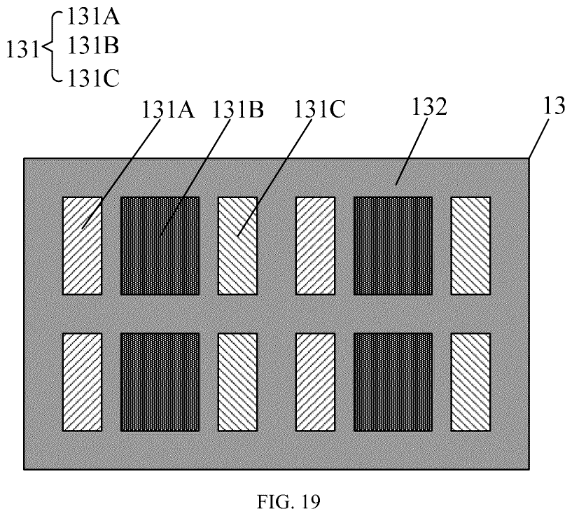

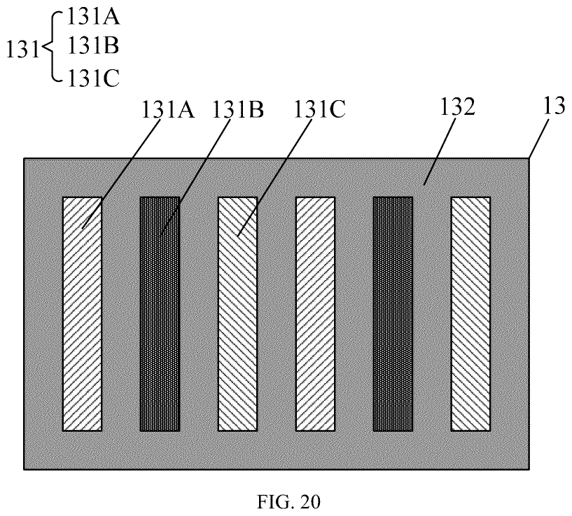

In an optional embodiment of the present disclosure, referring to FIGS. 16 to 20, FIG. 16 is a schematic diagram of zoning of yet another wavelength-selective reflective film according to an embodiment of the present disclosure, FIG. 17 is a schematic diagram of zoning of yet another wavelength-selective reflective film according to an embodiment of the present disclosure, FIG. 18 is a schematic diagram of zoning of yet another wavelength-selective reflective film according to an embodiment of the present disclosure, FIG. 19 is a schematic diagram of zoning of yet another wavelength-selective reflective film according to an embodiment of the present disclosure, FIG. 20 is a schematic diagram of zoning of yet another wavelength-selective reflective film according to an embodiment of the present disclosure, the wavelength-selective reflective film 13 according to the embodiment of the present disclosure further includes a second region 132, and on a plane where the wavelength-selective reflective film 13 is located, an orthographic projection of the second region 132 does not overlap with orthographic projections of the first regions 131.

The second region 132 includes a light-absorbing film layer.

In an embodiment of the present disclosure, the light-absorbing film layer includes but is not limited to a Black Matrix (BM) film layer. Light incident to the second region 132 can be absorbed by the light-absorbing film layer, so as to avoid the occurrence of the problem of light crosstalk between the light reflected by two adjacent first regions 131, thereby improving the display effect of the heads up display system 100.

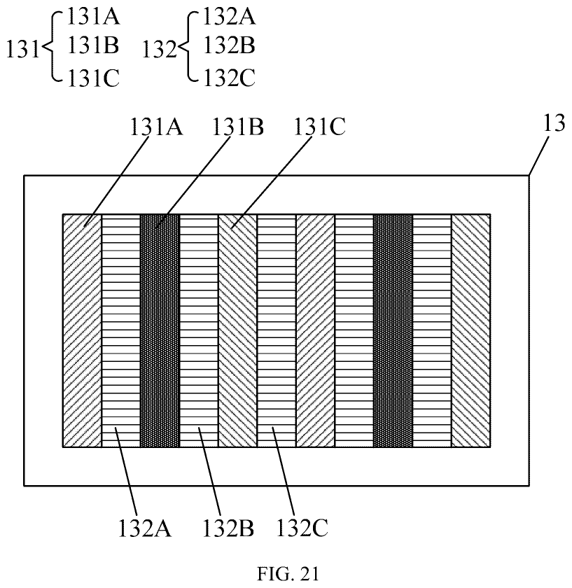

In an optional embodiment of the present disclosure, referring to FIG. 21, which is a schematic diagram of zoning of yet another wavelength-selective reflective film according to an embodiment of the present disclosure, the wavelength-selective reflective film 13 according to the embodiment of the present disclosure further includes second regions 132, and a part of the second regions 132 are located between two adjacent first regions 131.

A part of the second regions 132 simultaneously reflect the red light emitted by the red sub-pixels 111 and the green light emitted by the green sub-pixels 112, and/or a part of the second regions 132 simultaneously reflect the red light emitted by the red sub-pixels 111 and the blue light emitted by the blue sub-pixels 113, a part of the second regions 132 simultaneously reflect the green light emitted by the green sub-pixels 112 and the blue light emitted by the blue sub-pixels 113, and a part of the second regions 132 reflect the white light emitted by the white sub-pixels 114.

In an embodiment of the present disclosure, the second region 132 between two adjacent first regions 131 can be compatible with the reflection of adjacent colors. For example, the region labeled 132A simultaneously reflects red light emitted by the red sub-pixels 111 and green light emitted by the green sub-pixels 112, the region labeled 132B simultaneously reflects green light emitted by the green sub-pixels 112 and blue light emitted by the blue sub-pixels 113, and the region labeled 132C simultaneously reflects red light emitted by the red sub-pixels 111 and blue light emitted by the blue sub-pixels 113.

With this design, it is possible to enable the wavelength-selective reflective film 13 to reflect more light, improve the light extraction rate of each color light, and thus improve the display effect of the heads up display system 100.

In an optional embodiment of the present disclosure, when the first mirror 121 is located above a light-emitting side of the image generating device 11 and the wavelength-selective reflective film 13 is located on the reflective surface of the first mirror 121, at least one first region 131 includes a target region, the plurality of sub-pixels include a target sub-pixel, and color light reflected by the target region is the same as color light emitted by the target sub-pixel. An orthographic projection of the target region in a first direction overlaps with a region where the target sub-pixel is located, and the first direction is perpendicular to a plane where the image generating device 11 is located.

In the embodiments of the present disclosure, when the first mirror 121 is located above the light-emitting side of the image generating device 11 and the wavelength-selective reflective film 13 is located on the reflective surface of the first mirror 121, the corresponding relationship between the first regions 131 in the wavelength-selective reflective film 13 and the sub-pixels can be designed more simply, as long as it can be ensured that the orthographic projection of the target region in the first direction overlaps with the region where the target sub-pixel is located. In this way, it can be ensured that the light emitted by the target sub-pixel is received and reflected by the target region.

To enable the light emitted by the target sub-pixel to be received and reflected by the target region as much as possible or entirely, the overlap between the orthographic projection of the target region in the first direction and the region where the target sub-pixel is located can be optimally designed, for example, the orthographic projection of the target region in the first direction completely covers the region where the target sub-pixel is located.

It should be noted that in a case where the wavelength-selective reflective film 13 is located on the reflective surface of the second mirror 122, the corresponding relationship between the first regions 131 in the wavelength-selective reflective film 13 and the sub-pixels can also be designed based on the propagation of the optical path.

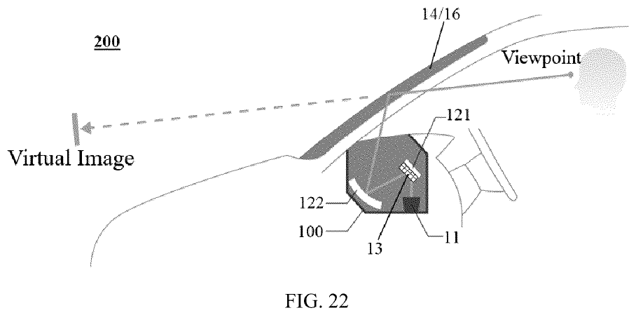

Based on the above-mentioned embodiments of the present disclosure, another embodiment of the present disclosure further provides a vehicle. Referring to FIG. 22, which is a schematic diagram of a vehicle equipped with a heads up display system according to an embodiment of the present disclosure, the vehicle 200 includes but is not limited to the heads up display system 100 of any of the above embodiments.

In an embodiment, the vehicle 200 may include a heads up display system 100 and a front windshield 16. The heads up display system 100 can acquire relevant parameter information and other information, and display them in the form of image light. The relevant parameter information may include speed per hour, status, navigation information of the vehicle 200, etc.

In an embodiment, the heads up display system 100 can be arranged on a dashboard of the vehicle 200, and can emit the image light toward the front windshield 16, and the image light is projected onto the front windshield 16. A driver can obtain parameter information, navigation information, etc. of the vehicle 200 through the front windshield 16 to facilitate subsequent driving and improve driving safety.

In the embodiment of the present disclosure, the case where the wavelength-selective reflective film 13 in the heads up display system 100 is located on the reflective surface of the first mirror 121 is taken as an example for illustration.

It should be noted that the wavelength-selective reflective film 13 in the heads up display system 100 provided by the embodiments of the present disclosure can also be located on the front windshield 16. External interference light first enters the front windshield 16, and at this time, the wavelength-selective reflective film 13 on the front windshield 16 can absorb and filter out most of the external interference light, and reduce most of the energy of the external interference light, thereby reducing the heat dissipation requirement of the subsequent optical path.

It should be noted that the projection surface 14 in the embodiments of the present disclosure can be the front windshield, side windshield, rear windshield of the vehicle, etc. In the embodiments of the present disclosure, only the projection surface 14 being the front windshield 16 of the vehicle is taken as an example for illustration.

A heads up display system and a vehicle provided by the present disclosure have been introduced in detail above. Specific examples are applied herein to elaborate on the principles and implementations of the present disclosure, and the descriptions of the above embodiments are only used to help understand the method of the present disclosure and its core idea. At the same time, for those of ordinary skill in the art, based on the idea of the present disclosure, there will be changes in the specific implementations and disclosure scopes. In conclusion, the content of this specification should not be understood as a limitation on the present disclosure.

It should be noted that each embodiment in this specification focuses on explaining the differences from other embodiments, and the same or similar parts between the various embodiments can be referred to each other.

It should also be noted that the relational terms such as “first” and “second” herein are only used to distinguish one entity from another entity or one operation from another operation, and do not necessarily require or imply that there is any such actual relationship or order between these entities or operations. Moreover, the terms “include”, “comprise” or any other variants thereof are intended to cover non-exclusive inclusion, so that a process, method, article or device including a series of elements also includes the inherent elements of such a process, method, article or device. Without more restrictions, an element defined by the sentence “including a . . . ” does not exclude the existence of another identical element in a process, method, article or device that includes the element.

The above description of the disclosed embodiments enables those of skill in the art to implement or use the present disclosure. Various modifications to these embodiments will be apparent to those of skill in the art, and the general principles defined herein can be implemented in other embodiments without departing from the spirit or scope of the present disclosure. Therefore, the present disclosure will not be limited to these embodiments shown herein, but should conform to the widest scope consistent with the principles and novel features disclosed herein.

What is claimed is:

1. A heads up display system, comprising:
an image generating device;
a reflective assembly configured to reflect image light emitted by the image generating device to a projection surface; and
a wavelength-selective reflective film located on a reflective surface of the reflective assembly and configured to reflect at least part of the image light.

2. The heads up display system according to claim 1, wherein the reflective assembly comprises a first mirror and a second mirror sequentially arranged in a transmission optical path of the image light.

3. The heads up display system according to claim 2, wherein the first mirror is a plane mirror, and the second mirror is a concave mirror.

4. The heads up display system according to claim 3, wherein a display unit in the image generating device comprises a plurality of sub-pixels, and the plurality of sub-pixels comprise one or more of red sub-pixels, green sub-pixels, blue sub-pixels, and white sub-pixels; and
the wavelength-selective reflective film comprises at least one first region, part of the at least one first region reflects red light emitted by the red sub-pixels, or the part of the at least one first region reflects green light emitted by the green sub-pixels, or the part of the at least one first region reflects blue light emitted by the blue sub-pixels, or the part of the at least one first region reflects white light emitted by the white sub-pixels.

5. The heads up display system according to claim 4, wherein the wavelength-selective reflective film is a photonic crystal reflective film, wherein the photonic crystal reflective film comprises microsphere particles; and
diameters of the microsphere particles in part of the first region is different from diameters of the microsphere particles in another part of the first region, or volume fractions of the microsphere particles in part of the first region is different from volume fractions of the microsphere particles in another part of the first region.

6. The heads up display system according to claim 2, wherein the wavelength-selective reflective film is located on a reflective surface of the first mirror, or the wavelength-selective reflective film is located on a reflective surface of the second mirror.

7. The heads up display system according to claim 6, wherein a display unit in the image generating device comprises a plurality of sub-pixels, and the plurality of sub-pixels comprise one or more of red sub-pixels, green sub-pixels, blue sub-pixels, and white sub-pixels; and
the wavelength-selective reflective film comprises at least one first region, part of the at least one first region reflects red light emitted by the red sub-pixels, or the part of the at least one first region reflects green light emitted by the green sub-pixels, or the part of the at least one first region reflects blue light emitted by the blue sub-pixels, or the part of the at least one first region reflects white light emitted by the white sub-pixels.

8. The heads up display system according to claim 7, wherein the wavelength-selective reflective film is a photonic crystal reflective film, wherein the photonic crystal reflective film comprises microsphere particles; and
diameters of the microsphere particles in part of the first region is different from diameters of the microsphere particles in another part of the first region, or volume fractions of the microsphere particles in part of the first region is different from volume fractions of the microsphere particles in another part of the first region.

9. The heads up display system according to claim 2, wherein a display unit in the image generating device comprises a plurality of sub-pixels, and the plurality of sub-pixels comprise one or more of red sub-pixels, green sub-pixels, blue sub-pixels, and white sub-pixels; and
the wavelength-selective reflective film comprises at least one first region, part of the at least one first region reflects red light emitted by the red sub-pixels, or the part of the at least one first region reflects green light emitted by the green sub-pixels, or the part of the at least one first region reflects blue light emitted by the blue sub-pixels, or the part of the at least one first region reflects white light emitted by the white sub-pixels.

10. The heads up display system according to claim 9, wherein light-emitting areas of the plurality of sub-pixels are the same.

11. The heads up display system according to claim 9, wherein the plurality of sub-pixels comprise the red sub-pixels, the green sub-pixels, and the blue sub-pixels, a light-emitting area of one of the red sub-pixels is S1, a light-emitting area of one of the green sub-pixels is S2, and a light-emitting area of one of the blue sub-pixels is S3; and
wherein, S1>S2>S3.

12. The heads up display system according to claim 9, wherein the plurality of sub-pixels comprise the red sub-pixels, the green sub-pixels, and the blue sub-pixels, a light-emitting area of one of the red sub-pixels is S1, a light-emitting area of one of the green sub-pixels is S2, and a light-emitting area of one of the blue sub-pixels is S3; and
wherein, S2>S1 and S2>S3.

13. The heads up display system according to claim 9, wherein the wavelength-selective reflective film further comprises a second region, and on a plane of the wavelength-selective reflective film, an orthographic projection of the second region does not overlap with an orthographic projection of the at least one first region; and
the second region comprises a light-absorbing film layer.

14. The heads up display system according to claim 9, wherein the wavelength-selective reflective film further comprises second regions, and a part of the second regions are located between two adjacent first regions; and
a part of the second regions simultaneously reflect the red light emitted by the red sub-pixels and the green light emitted by the green sub-pixels, or a part of the second regions simultaneously reflect the red light emitted by the red sub-pixels and the blue light emitted by the blue sub-pixels, a part of the second regions simultaneously reflect the green light emitted by the green sub-pixels and the blue light emitted by the blue sub-pixels, and a part of the second regions reflect the white light emitted by the white sub-pixels.

15. The heads up display system according to claim 9, wherein the first mirror is located above a light-emitting side of the image generating device and the wavelength-selective reflective film is located on the reflective surface of the first mirror;
the at least one first region comprises a target region, the plurality of sub-pixels comprises a target sub-pixel, and color light reflected by the target region is the same as color light emitted by the target sub-pixel; and
an orthographic projection of the target region in a first direction overlaps with a region of the target sub-pixel, and the first direction is perpendicular to a plane of the image generating device.

16. The heads up display system according to claim 9, wherein the wavelength-selective reflective film is a photonic crystal reflective film, wherein the photonic crystal reflective film comprises microsphere particles; and
diameters of the microsphere particles in part of the first region is different from diameters of the microsphere particles in another part of the first region, or volume fractions of the microsphere particles in part of the first region is different from volume fractions of the microsphere particles in another part of the first region.

17. The heads up display system according to claim 14, wherein a material of the microsphere particles is silicon dioxide (SiO₂), polymeric methyl methacrylate (PMMA), or polystyrene (PS).

18. A vehicle comprising a heads up display system;
wherein the heads up display system comprises:
an image generating device;
a reflective assembly configured to reflect image light emitted by the image generating device to a projection surface; and
a wavelength-selective reflective film located on a reflective surface of the reflective assembly and configured to reflect at least part of the image light.

19. The vehicle according to claim 18, further comprising a front windshield,
wherein the wavelength-selective reflective film in the heads up display system is located on the front windshield.
